(19) United States
(12) Patent Application Publication
(10) Pub. No.: US 2016/0078350 A1
(43) Pub. Date: Mar. 17, 2016

(54) CONTEXTUAL PLATFORM FEATURE RECOMMENDATIONS

(71) Applicants: Mark D. Yarvis, Portland, OR (US); Mark MacDonald, Beaverton, OR (US); Charles H. Winstead, Portland, OR (US); Wah Yiu Kwong, Beaverton, OR (US); Daniel S. Willis, Portland, OR (US)

(72) Inventors: Mark D. Yarvis, Portland, OR (US); Mark MacDonald, Beaverton, OR (US); Charles H. Winstead, Portland, OR (US); Wah Yiu Kwong, Beaverton, OR (US); Daniel S. Willis, Portland, OR (US)

(21) Appl. No.: 14/488,809

(22) Filed: Sep. 17, 2014

(51) Int. Cl. G06N 5/04

(52) U.S. Cl. CPC G06N 5/04

(57) ABSTRACT

Technologies for contextual platform recommendations including a computing device with a number of platform capabilities, including any combination of hardware capabilities and software capabilities. The computing device stores context data based on the current context of the computing device and determines a user profile based on the context data. The user profile is indicative of typical behavior of the user of the computing device. The computing device determines a recommended platform capability from a number of available platform capabilities based on the user profile. The computing device notifies the user of the recommended platform capability. The computing device may also provide the notification only when the recommended platform capability is relevant to the current device context. The computing device may transmit the user profile to a recommendation service, which may generate additional recommendations for platform capabilities. Other embodiments are described and claimed.

### BACKGROUND

Typical computing devices have many features, including hardware, firmware, and software features. Those features may add value to the computing device in particular contexts or particular usage scenarios. Some manufacturers activate or enable all available features on the computing device prior to delivering the computing device to an end user. However, some features may not be relevant to all users, and therefore may be considered to be unnecessary “bloat-ware” by some users. Alternatively, some manufactures may not enable all available features on the computing device. However, on first use, such a computing device may prompt the user to enable or disable every available feature. If the user does not activate the feature on first use, the feature may never be activated. If the user is not prompted on first use, the user may not become aware of the available feature.

Some online stores maintained by computer manufactures may recommend platform features for new purchases based on historical hardware usage data for an existing device from the same manufacturer. The usage data analyzed may be limited to hardware performance data such as processor, memory, and/or disk performance. Additionally, the recommendations are generated by the online store and not the existing device itself.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for contextual platform feature recommendations;

FIG. 2 is a simplified block diagram of at least one embodiment of various environments that may be established by the system of FIG. 1;

FIG. 3 is a simplified flow diagram of at least one embodiment of a method for contextual platform feature recommendations that may be executed by a computing device of the system of FIGS. 1 and 2; and

FIG. 4 is a simplified flow diagram of at least one embodiment of a method for determining recommendation templates based on aggregate user profiles that may be executed by a recommendation service of the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

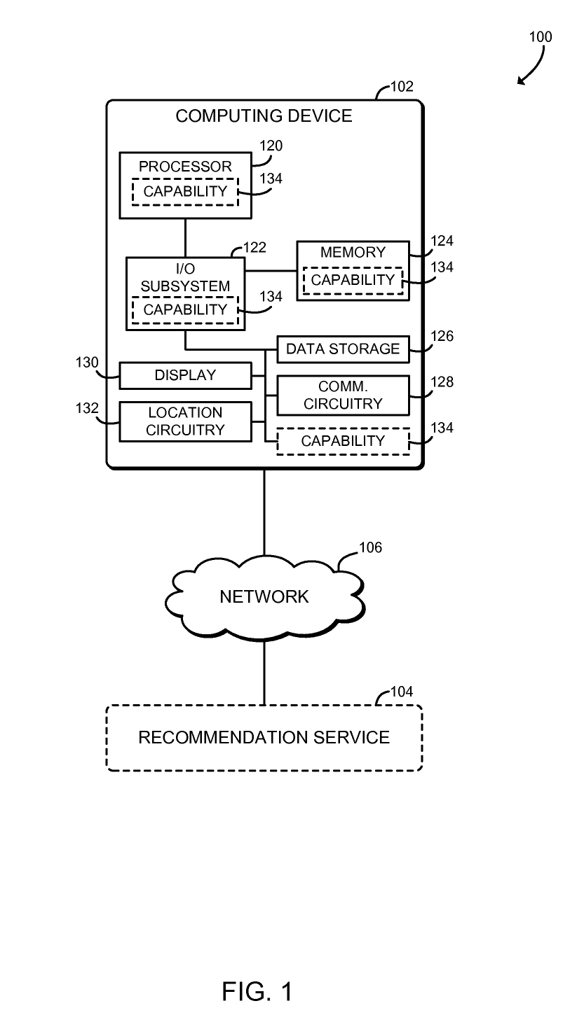

Referring now to FIG. 1, in an illustrative embodiment, a system 100 for contextual platform feature recommendations includes a computing device 102 and, in some embodiments, a recommendation service 104. The computing device 102 and the recommendation service 104 may be in communication with each other over a network 106. In use, as discussed in more detail below, the computing device 102 establishes a user profile based on the device context of the computing device 102. The user profile indicates typical behavior of a user of the computing device 102, such as geographical locations that the user frequently visits, typical application or content usage of the user, and/or computing resources that are typically available to the computing device 102. Based on the user profile, the computing device 102 determines one or more recommended platform capabilities and notifies the user of those platform capabilities. The computing device 102 may notify the user of platform capabilities only when those platform capabilities are relevant to the current context of the computing device 102. In some embodiments, the computing device 102 may transmit the user profile to the recommendation service 104, which may develop new recommendations based on aggregate user profile data received from many computing devices 102. Thus, by performing contextual platform feature recommendations, the computing device 102 may become more useful, usable, or capable and thus may provide better value to the user. Recommending contextually relevant platform features—and in some embodiments, only in relevant circumstances—improves the likelihood that the user will value the recommended platform features. Also, contextual recommendations of platform features may improve the first-use experience of the computing device 102 by eliminating excessive or annoying prompts and notifications.

The computing device 102 may be embodied as any type of computation or computer device capable of performing the functions described herein, including, without limitation, a computer, a smartphone, a tablet computer, a laptop computer, a notebook computer, a mobile computing device, a wearable computing device, a multiprocessor system, a server, a rack-mounted server, a blade server, a network appliance, a web appliance, a distributed computing system, a processor-based system, and/or a consumer electronic device. As shown in FIG. 1, the computing device 102 illustratively includes a processor 120, an input/output subsystem 122, a memory 124, a data storage device 126, and communication circuitry 128. Of course, the computing device 102 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. In use, as described below, the data storage device 126 may store software or firmware used to enable various platform features of the computing device 102. The communication circuitry 128 of the computing device 102 may be embodied as any communication circuit, device, or collection thereof, capable of enabling communications between the computing device 102, the recommendation service 104, and/or other remote devices over the network 106. The communication circuitry 128 may be configured to use any one or more communication technology (e.g., wired or wireless communications) and associated protocols (e.g., Ethernet, Bluetooth®, Wi-Fi®, WiMAX, etc.) to effect such communication.

The computing device 102 further includes a display 130. The display 130 of the computing device 102 may be embodied as any type of display capable of displaying digital information such as a liquid crystal display (LCD), a light emitting diode (LED), a plasma display, a cathode ray tube (CRT), or other type of display device. In some embodiments, the display 130 may be coupled to a touch screen to allow user interaction with the computing device 102.

In the illustrative embodiment, the computing device 102 includes location circuitry 132. The location circuitry 132 may be embodied as any type of circuit capable of determining the precise or approximate position of the computing device 102. For example, the location circuitry 132 may be embodied as a global positioning system (GPS) receiver, capable of determining the precise coordinates of the computing device 102. In other embodiments, the location circuitry 132 may triangulate the position of the computing device 102 using distances or angles to cellular network towers with known positions, provided by the communication circuit 128. In other embodiments, the location circuitry 132 may determine the approximate position of the computing device 102 based on association to wireless networks with known positions, using the communication circuit 128.

The computing device 102 also includes a number of platform capabilities 134. The platform capabilities 134 may be embodied as any feature or features that tend to improve the performance, functionality, usability, or other attributes of the computing device 102 and/or the components of the computing device 102. The platform capabilities 134 may include any combination of hardware, firmware, and software features of the computing device 102. Thus, as shown in FIG. 1, the platform capabilities 134 may be embodied as features of the processor 120, the I/O subsystem 122, the memory 124, and/or as separate components coupled to the I/O subsystem 122. For example, the platform capabilities 134 may include instruction sets, media acceleration, security features, functional units, or other features of the processor 120; I/O ports, security features, or other features of the I/O subsystem 122; or peripheral devices, including internal and external peripheral devices. The platform capabilities 134 may also include drivers, applications, frameworks, libraries, or other software modules resident in the memory 124 that may improve the performance, functionality, usability, or other attributes of or the computing device 102, or that enable other platform capabilities 134 of the computing device 102.

The recommendation service 104 may be embodied as any computing device, or collection of computing devices, capable of generating platform feature recommendations based on aggregate user profiles. As such, the recommendation service 104 may be embodied as a single server computing device or a collection of servers and associated devices. For example, in some embodiments, the recommendation service 104 may be embodied as a “virtual server” formed from multiple computing devices distributed across the network 106 and operating in a public or private cloud. Accordingly, although the recommendation service 104 is illustrated in FIG. 1 as embodied as a single server computing device, it should be appreciated that the recommendation service 104 may be embodied as multiple devices cooperating together to facilitate the functionality described below. As such, the recommendation service 104 may include components and features typically found in a server or other computing device. Such components and features, for example, may be similar to those of the computing device 102, such as a processor, I/O subsystem, memory, data storage, communication circuitry, and various peripheral devices, which are not illustrated in FIG. 1 for clarity of the present description.

As discussed in more detail below, the computing device 102 and the recommendation service 104 may be configured to transmit and receive data with each other and/or other remote devices over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, and switches, to facilitate communications among the devices of the system 100.

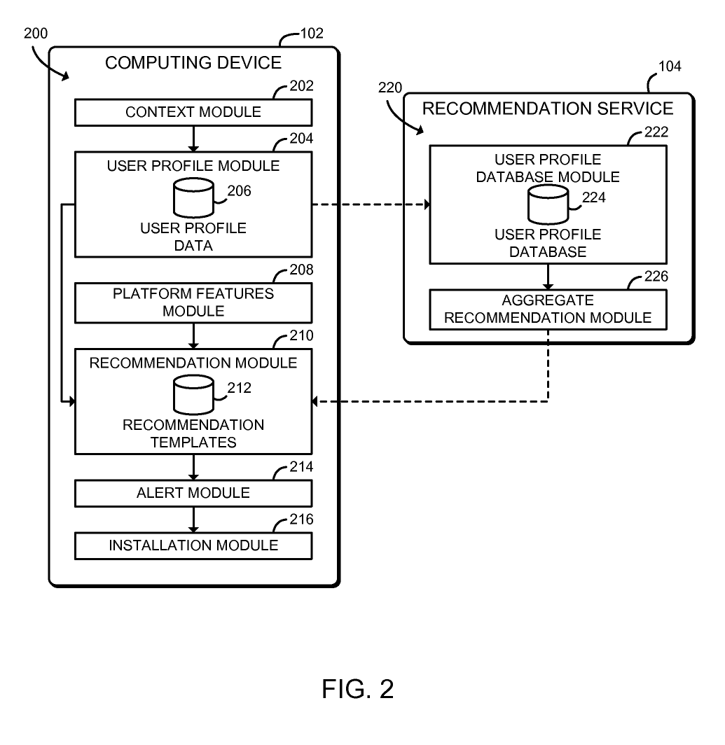

Referring now to FIG. 2, in an illustrative embodiment, the computing device 102 establishes an environment 200 during operation. The illustrative environment 200 includes a context module 202, a user profile module 204, a platform features module 208, a recommendation module 210, an alert module 214, and an installation module 216. The various modules of the environment 200 may be embodied as hardware, firmware, software, or a combination thereof.

The context module 202 is configured to monitor and record the current context of the computing device 102. As further described below, the device context may include the location of the computing device 102 as well as device usage, available computing resources, and other contextual aspects of the computing device 102. The context module 202 may maintain context data that records, aggregates, or otherwise stores the current context of the computing device 102 over time (i.e., historical context). The user profile module 204 is configured to determine a user profile based on the context data provided by the context module 202, which may include current and/or historical context data. The user profile module 204 may store, update, or otherwise maintain the user profile using user profile data 206. It should be appreciated that the user profile data 206 may be indicative of typical behavior of the user of the computing device 102. As described below, in some embodiments the user profile module 204 may provide the user profile data 206 to the recommendation service 104 to generate aggregated recommendations.

The platform features module 208 is configured to identify available platform capabilities 134 of the computing device 102. The platform capabilities 134 may include any feature or other functionality that the computing device 102 may be capable of performing, including features that have not previously been enabled, installed, or otherwise activated. As described above, the available platform capabilities 134 may include processor capabilities, chipset capabilities, other hardware capabilities, firmware capabilities, software capabilities, or any combination of those capabilities.

The recommendation module 210 is configured to select one or more recommended platform capabilities 134 from the available platform capabilities 134, based on the user profile data 206. The recommendation module 210 may maintain a number of recommendation templates 212. Each recommendation template 212 may match a particular device context with a recommended platform capability 134. Thus, the recommendation module 210 may determine recommended platform capabilities 134 by selecting recommendation templates 212 that match the context indicated by the user profile data 206 and the available set of platform features from the platform features module 208. In some embodiments, the recommendation module 210 may receive one or more of the recommendation templates 212 from the recommendation service 104.

The alert module 214 is configured to notify the user of recommended platform capabilities 134. The alert module 214 may notify the user using any available mode of user interaction, including displaying a notification on the display 130, issuing an audible notification, or performing another type of notification. The alert module 214 may be configured to limit the number or rate of notifications presented to the user to prevent overloading or annoying the user, for example by notifying the user only when the recommended platform capability 134 is relevant to the current device context. The installation module 216 is configured to install software or other components necessary to install, enable, or otherwise activate the recommended platform capabilities 134. The installation module 216 may install the recommended platform capabilities 134 in response to a user command, or without user intervention.

Still referring to FIG. 2, in some embodiments, the recommendation service 104 may establish an environment 220 during operation. The illustrative environment 220 includes a user profile database module 222 and an aggregate recommendation module 226. The various modules of the environment 220 may be embodied as hardware, firmware, software, or a combination thereof.

The user profile database module 222 is configured to receive user profile data 206 from one or more computing devices 102 and to store the user profile data 206 in a user profile database 224. The user profile database 224 may be anonymized. For example, personally identifying information in the user profile data 206 may be removed or obscured. The user profile database module 222 is additionally configured to identify common device contexts occurring in the user profile database 224, which may be indicative of typical behavior of a large number of users.

The aggregate recommendation module 226 is configured to determine new recommendation templates 212 for common contexts identified in the user profile database 224. The aggregate recommendation module 226 may use any technique to determine the new recommendation templates 212, including automatic and manual techniques. The aggregate recommendation module 226 is further configured to transmit the new recommendation templates 212 to the computing devices 102 for use.

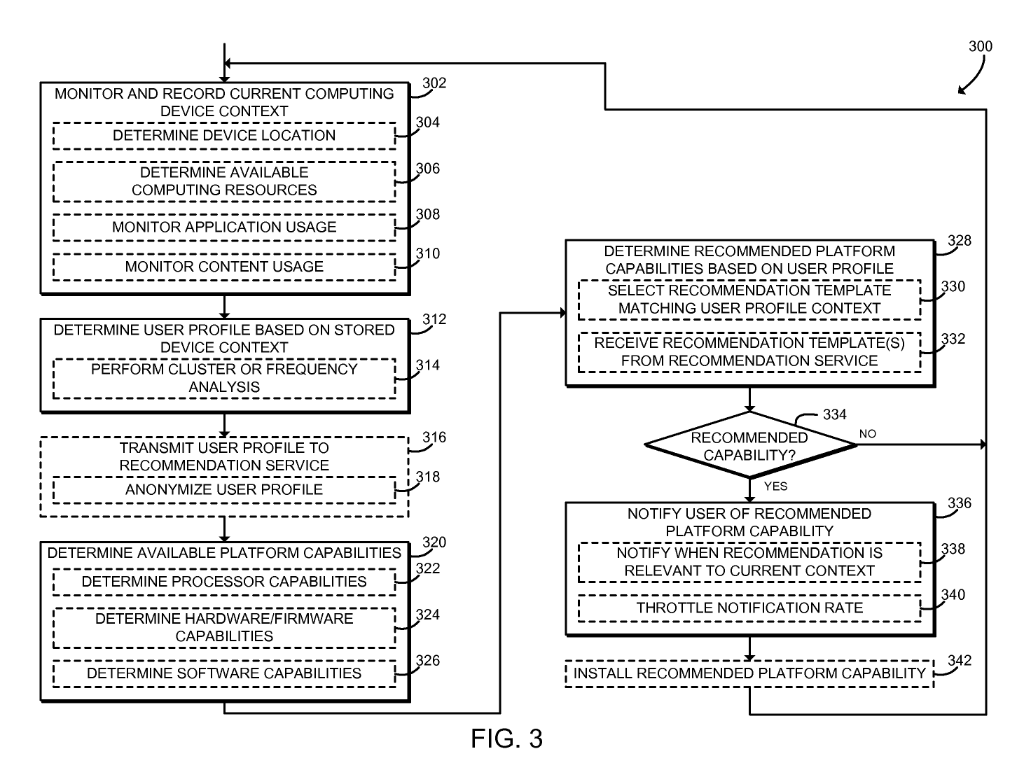

Referring now to FIG. 3, in use, the computing device 102 may execute a method 300 for contextual recommendations of platform capabilities 134. The method 300 begins in block 302, in which the computing device 102 monitors and records the current device context. The device context may include any information indicative of any useful context aspects of the computing device 102 such as, for example, the physical location of the computing device 102, device usage, available computing resources, other nearby devices, and/or other contextual aspects of the computing device 102. The computing device 102 may store, aggregate, or otherwise record context data indicative of the context of the computing device 102 over time. Accordingly, in some embodiments, in block 304 the computing device 102 may determine the location of the computing device 102. For example, the computing device 102 may use the location circuitry 132 to determine the geographical location of the computing device 102. The computing device 102 may also determine other aspects of the device location, for example the street address, building, nearby businesses or services, or other such information.

In some embodiments, in block 306 the computing device 102 may determine available computing resources in the current device context. Computing resources may include peripheral devices such as wireless displays, projectors, printers, or other devices accessible to the computing device 102. For example, the computing device 102 may detect an Intel® Wireless Display (“WiDi”)-enabled display that is available in the current context of the computing device 102. Additionally or alternatively, the available computing resources may include available computer networks or other proximate computing devices available over a computing network in the current context of the computing device 102. For example, the computing device 102 may determine that one or more remote computing devices supporting a collaborative or peer-to-peer networking protocol such as the Intel® Common Connectivity Framework (“CCF”) is available in the current context of the computing device 102.

In some embodiments, in block 308 the computing device 102 may monitor current application usage. Similarly, in some embodiments, in block 310 the computing device 102 may monitor current content usage. For example, the computing device 102 may monitor the current web pages, documents, videos, or other content being accessed by the user with the computing device 102.

After collecting the context data, in block 312 the computing device 102 determines user profile data 206 based on the stored device context. The user profile data 206 is indicative of typical behavior of the user of the computing device 102 and, thus, may describe typical locations in which the user uses the computing device 102, computing resources typically available to the computing device 102, typical application and content usage of the computing device 102, or any other aspects of typical user behavior. The computing device 102 may use any pattern recognition, artificial intelligence, data mining, or other algorithm to generate the user profile data 206. In some embodiments, in block 314 the computing device 102 may perform cluster analysis or frequency analysis to generate the user profile data 206.

In some embodiments, in block 316 the computing device 102 may transmit the user profile data 206 to the recommendation service 104. Additionally, in some embodiments in block 318 the computing device 102 may anonymize the user profile data 206 prior to transmission to the recommendation service 104, to remove or obscure personally identifiable information relating to the user. As further described below, the recommendation service 104 may collect user profile data 206 from many computing devices 102 and use the aggregated user profiles to generate additional recommendation templates 212.

In block 320, the computing device 102 determines available platform capabilities 134 of the computing device 102. The platform capabilities 134 may include any feature or other functionality the computing device 102 may be capable of performing, including features that have not previously been enabled, installed, or otherwise activated. As described above, the available platform capabilities 134 may include processor capabilities, chipset capabilities, other hardware capabilities, firmware capabilities, software capabilities, or any combination of those capabilities. For example, the platform capabilities 134 may include a wireless display capability such as Intel® WiDi, an anti-theft capability such as Intel® Anti-Theft Technology, a near-field communication capability, a collaborative networking capability such as Intel® CCF, a standby network update capability such as Intel® Smart Connect Technology, a remote wake capability such as Wake-on-LAN (“WOL”), a hardware root of trust capability such as Intel® Identity Protection Technology, or a content protection capability such as Intel® Insider™.

In some embodiments, in block 322 the computing device 102 may determine available platform capabilities 134 of the processor 120. As described above, platform capabilities 134 of the processor 120 may include instruction sets, media acceleration, security features, functional units, or other features of the processor 120. Additionally, in some embodiments, in block 324 the computing device 102 may determine available hardware and/or firmware platform capabilities 134 of the computing device 102, including platform capabilities 134 of the I/O subsystem 122 and/or peripheral devices of the computing device 102. In some embodiments, in block 326 the computing device 102 may determine available software platform capabilities 134 of the computing device 102. The computing device 102 may determine the various platform capabilities 134 using any suitable methodology including, for example, maintaining a list or similar data structure of available capabilities, interrogating hardware and/or software components of the computing device 102 to discover available capabilities, receiving notifications of available platform capabilities, and/or any other method usable to determine or discover platform capabilities.

In block 328, the computing device 102 determines recommended platform capabilities 134 based on the user profile data 206 and the available platform capabilities 134 determined in block 322. To do so, the computing device 102 may select any number of available platform capabilities 134 that are directed toward, appropriate, or otherwise relevant to the context indicated by the user profile data 206. Those recommended platform capabilities 134 are likely to be useful or valuable to the user of the computing device 102. In some embodiments, in block 330, the computing device 102 may determine the recommended platform capabilities 134 by selecting one or more recommendation templates 212 that match the context indicated by the user profile data 206. Each of the matching recommendation templates 212 is in turn associated with a recommended platform capability 134. In some embodiments, the recommendation templates 212 may be pre-defined, for example by a manufacturer of the computing device 102 or by the operator of the recommendation service 104. In some embodiments, in block 332, the computing device 102 may receive one or more recommendation templates 212 from the recommendation service 104. As described above, the recommendation service 104 may create new recommendation templates 212 for platform capabilities 134 based on aggregate user profile data 206 received from many computing devices 102.

As an example recommendation, consider an embodiment in which the user profile data 206 indicates that the computing device 102 is frequently near an Intel® WiDi-capable television set, and that the user frequently uses video applications and/or visits video websites. Based on that user profile data 206, the computing device 102 may recommend using Intel® WiDi to display videos on the television set. As another example, consider an embodiment in which the user profile data 206 indicates that the computing device 102 travels frequently, for example, by indicating that the computing device 102 is often geographically located in airports and/or remote cities. Based on that user profile data 206, the computing device 102 may recommend enabling Intel® Anti-Theft Technology. As a third example, consider an embodiment in which the user profile data 206 indicates that the computing device 102 is frequently located in retail stores. Based on that user profile data 206, the computing device 102 may recommend enabling near-field communication technology to pay for purchases. As a fourth example, consider an embodiment in which the user profile data 206 indicates that the computing device 102 is often used to play social games, and that the computing device 102 is often near other computing devices supporting Intel® CCF. Based on that user profile data 206, the computing device 102 may recommend enabling Intel® CCF-based collaborative gaming experiences.

In block 334, the computing device 102 determines whether any recommended platform capabilities 134 have been identified. If not, the method 300 loops back to block 302 to continue monitoring the device context. If at least one recommended platform capability 134 has been identified, the method 300 advances to block 336.

In block 336, the computing device 102 notifies the user of the recommended platform capabilities 134. The computing device 102 may use any appropriate notification technique, such as displaying a message on the display 130, playing an alert sound, or sending a network message. The notification may present the user with information on the platform capability 134, including information describing how to enable the platform capability 134. In some embodiments, in block 338, the computing device 102 may notify the user when the recommended platform capability 134 of the computing device 102 is relevant to the current device context. Thus, the computing device 102 may avoid presenting irrelevant recommendations that may annoy the user or otherwise degrade the user experience. In some embodiments, the computing device 102 may determine that the platform capability 134 is relevant to the current device context when the recommended platform capability 134 is usable while the computing device 102 is in the current device context. For example, the computing device 102 may recommend enabling a wireless display when the wireless display is usable by the computing device 102, but not otherwise recommend the wireless display. As another example, the computing device 102 may recommend activating a collaborative network application when another computing device supporting the collaborative network application is proximate or otherwise usable. In some embodiments, in block 340, the computing device 102 may throttle or otherwise limit the rate of notifications to avoid annoying or overloading the user. For example, the computing device 102 may suppress notifications when the current notification rate exceeds a predefined threshold rate. Additionally or alternatively, the computing device 102 may coalesce notifications to reduce the notification rate.

In some embodiments, after notifying the user, in block 342 the computing device 102 may install the recommended platform capabilities 134. The computing device 102 may download, install, configure, or otherwise prepare for use any software modules or other components necessary to activate the platform capability 134. In some embodiments, the computing device 102 may install the platform capabilities 134 in the background or otherwise without user intervention. Additionally or alternatively, in some embodiments the computing device 102 may prompt the user for confirmation prior to installing or activating the platform capabilities 134. After notifying the user and, in some embodiments, installing the platform capabilities 134, the method 300 loops back to block 302 to continue monitoring the device context.

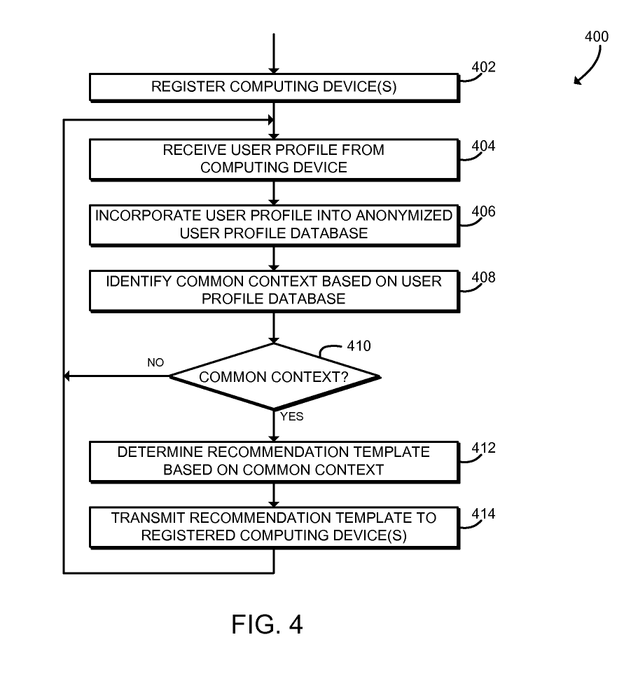

Referring now to FIG. 4, in use, the recommendation service 104 may execute a method 400 for determining recommendation templates 212 based on aggregate user profiles. The method 400 begins with block 402, in which the recommendation service 104 registers one or more computing devices 102. Registration may allow the recommendation service 104 to receive user profiles from each of the computing devices 102 and to transmit recommendation templates 212 back to each of the computing devices 102. Of course, in some embodiments, registration of computing devices 102 may not be required. For example, rather than registering computing devices 102 to receive recommendation templates 212, the recommendation service 104 may respond to requests originating from the computing devices 102, make the recommendation templates 212 publicly available, or otherwise distribute the recommendation templates 212.

In block 404, the recommendation service 104 receives user profile data 206 from a computing device 102. As described above, the user profile data 206 is indicative of typical behavior of a user of that computing device 102. The user profile data 206 may be anonymized by the computing device 102 prior to being transmitted to the recommendation service 104, or may include personally identifiable data.

In block 406, the recommendation service 104 incorporates the user profile data 206 into the anonymized user profile database 224. If the user profile data 206 received from the computing device 102 contains personally-identifiable information, the recommendation service 104 may anonymize the user profile data 206 prior to incorporating it into the user profile database 224. Thus, the user profile database 224 may contain aggregated data that is indicative of typical behavior of a large number of users of a large number of computing devices 102.

In block 408, the recommendation service 104 may identify common device contexts based on the user profile database 224. The common contexts may indicate typical usage scenarios performed by large numbers of users. The recommendation service 104 may use any technique to identify common contexts, including frequency analysis, clustering algorithms, or other algorithms. In block 410, the recommendation service 104 determines whether any common contexts have been identified. If not, the method 400 loops back to block 404 to continue receiving user profile data 206. If one or more common contexts have been identified, the method 400 advances to block 412.

In block 412, the recommendation service 104 determines new recommendation templates 212 appropriate for the common contexts previously identified. As described above, each recommendation template 212 matches a particular context with a recommended platform capability 134. The recommendation service 104 may use any technique to determine the new recommendation templates 212, including receiving recommendations from a user (e.g., a platform engineer or other domain expert) or determining recommendations without user intervention.

In block 414, the recommendation service 104 transmits the new recommendation templates 212 to one or more of the registered computing devices 102. The recommendation service 104 may transmit the recommendation to all registered computing devices 102, including computing devices 102 that have not transmitted user profile data 206 or that have not transmitted user profile data 206 that matches the context of the new recommendation templates 212. Thus, the recommendation service 104 may propagate new recommendation templates 212 among all of the computing devices 102, allowing the computing devices 102 to adapt to new contexts and new usage scenarios. Of course, as described above, rather than transmitting the recommendation templates 212 to all registered computing devices 102, in some embodiments the recommendation service 104 may respond to requests for the recommendation templates 212 that originate from the computing devices 102. After transmitting the recommendation templates 212, the method 400 loops back to block 404 to continue receiving user profile data 206.

### EXAMPLES

Illustrative examples of the technologies disclosed herein are provided below. An embodiment of the technologies may include any one or more, and any combination of, the examples described below.

Example 1 includes a computing device for recommending platform features, the computing device comprising a context module to determine context data indicative of a context of the computing device; a user profile module to determine a user profile based on the context data, the user profile indicative of a typical behavior of a user of the computing device; a platform features module to determine a plurality of available platform capabilities of the computing device; a recommendation module to determine a recommended platform capability of the plurality of available platform capabilities based on the user profile; and an alert module to notify the user of the recommended platform capability.

Example 2 includes the subject matter of Example 1, and wherein to determine the context data comprises to retrieve context data indicative of a historical context of the computing device.

Example 3 includes the subject matter of any of Examples 1 and 2, and wherein to determine the context data comprises to determine context data indicative of a current location of the computing device.

Example 4 includes the subject matter of any of Examples 1-3, and wherein to determine the context data comprises to determine context data indicative of a currently available computing resource.

Example 5 includes the subject matter of any of Examples 1-4, and wherein the available computing resource comprises a wireless display, a network, or a proximate computing device.

Example 6 includes the subject matter of any of Examples 1-5, and wherein to determine the context data comprises to determine context data indicative of application usage of the computing device.

Example 7 includes the subject matter of any of Examples 1-6, and wherein to determine the context data comprises to determine context data indicative of content usage of the computing device.

Example 8 includes the subject matter of any of Examples 1-7, and wherein to determine the user profile comprises to perform cluster analysis or frequency analysis to identify the typical behavior.

Example 9 includes the subject matter of any of Examples 1-8, and wherein the plurality of available platform capabilities comprises at least one of a processor capability, a chipset capability, a hardware capability, or a software capability of the computing device.

Example 10 includes the subject matter of any of Examples 1-9, and wherein the plurality of available platform capabilities comprises at least one of a wireless display capability, an anti-theft capability, a near-field communication capability, a collaborative networking capability, a standby network update capability, a remote wake capability, a hardware root of trust capability, or a content protection capability.

Example 11 includes the subject matter of any of Examples 1-10, and wherein to determine the recommended platform capability comprises to select a recommendation template to match the user profile from a plurality of pre-defined recommendation templates, the recommendation template to identify the recommended platform capability.

Example 12 includes the subject matter of any of Examples 1-11, and wherein the recommendation module is further to receive a recommendation template from a recommendation service.

Example 13 includes the subject matter of any of Examples 1-12, and wherein the user profile module is further to transmit the user profile to the recommendation service.

Example 14 includes the subject matter of any of Examples 1-13, and wherein the alert module is further to determine whether the recommended platform capability is relevant to the current context of the computing device; and to notify the user of the recommended platform capability comprises to notify the user in response to a determination that the recommended platform capability is relevant to the current context of the computing device.

Example 15 includes the subject matter of any of Examples 1-14, and wherein to notify the user of the recommended platform capability comprises to determine a notification rate of the computing device; determine whether the notification rate has a predefined relationship to a threshold notification rate; and notify the user in response to a determination that the notification rate has the predefined relationship with the threshold notification rate.

Example 16 includes the subject matter of any of Examples 1-15, and further including an installation module to install a software component to enable the recommended platform capability.

Example 17 includes a method for recommending platform features, the method comprising determining, by a computing device, context data indicative of a context of the computing device; determining, by the computing device, a user profile based on the context data, the user profile indicative of a typical behavior of a user of the computing device; determining, by the computing device, a plurality of available platform capabilities of the computing device; determining, by the computing device, a recommended platform capability of the plurality of available platform capabilities based on the user profile; and notifying, by the computing device, the user of the recommended platform capability.

Example 18 includes the subject matter of Example 17, and wherein determining the context data comprises retrieving context data indicative of a historical context of the computing device.

Example 19 includes the subject matter of any of Examples 17 and 18, and wherein determining the context data comprises determining context data indicative of a current location of the computing device.

Example 20 includes the subject matter of any of Examples 17-19, and wherein determining the context data comprises determining context data indicative of a currently available computing resource.

Example 21 includes the subject matter of any of Examples 17-20, and wherein determining the available computing resource comprises identifying a wireless display, a network, or a proximate computing device.

Example 22 includes the subject matter of any of Examples 17-21, and wherein determining the context data comprises determining context data indicative of application usage of the computing device.

Example 23 includes the subject matter of any of Examples 17-22, and wherein determining the context data comprises determining context data indicative of content usage of the computing device.

Example 24 includes the subject matter of any of Examples 17-23, and wherein determining the user profile comprises performing cluster analysis or frequency analysis to identify the typical behavior.

Example 25 includes the subject matter of any of Examples 17-24, and wherein determining the plurality of available platform capabilities comprises determining at least one of a processor capability, a chipset capability, a hardware capability, or a software capability of the computing device.

Example 26 includes the subject matter of any of Examples 17-25, and wherein determining the plurality of available platform capabilities comprises determining at least one of a wireless display capability, an anti-theft capability, a near-field communication capability, a collaborative networking capability, a standby network update capability, a remote wake capability, a hardware root of trust capability, or a content protection capability.

Example 27 includes the subject matter of any of Examples 17-26, and wherein determining the recommended platform capability comprises selecting a recommendation template matching the user profile from a plurality of pre-defined recommendation templates, the recommendation template identifying the recommended platform capability.

Example 28 includes the subject matter of any of Examples 17-27, and further including receiving, by the computing device, a recommendation template from a recommendation service.

Example 29 includes the subject matter of any of Examples 17-28, and further including transmitting, by the computing device, the user profile to the recommendation service.

Example 30 includes the subject matter of any of Examples 17-29, and further including determining, by the computing device, whether the recommended platform capability is relevant to the current context of the computing device; wherein notifying the user of the recommended platform capability comprises notifying the user in response to determining that the recommended platform capability is relevant to the current context of the computing device.

Example 31 includes the subject matter of any of Examples 17-30, and wherein notifying the user of the recommended platform capability comprises determining a notification rate of the computing device; determining whether the notification rate has a predefined relationship to a threshold notification rate; and notifying the user in response to determining the notification rate has the predefined relationship with the threshold notification rate.

Example 32 includes the subject matter of any of Examples 17-31, and further including installing, by the computing device, a software component enabling the recommended platform capability.

Example 33 includes a computing device comprising a processor; and a memory having stored therein a plurality of instructions that when executed by the processor cause the computing device to perform the method of any of Examples 17-32.

Example 34 includes one or more machine readable storage media comprising a plurality of instructions stored thereon that in response to being executed result in a computing device performing the method of any of Examples 17-32.

Example 35 includes a computing device comprising means for performing the method of any of Examples 17-32.

Example 36 includes a computing device for recommending platform features, the computing device comprising means for determining context data indicative of a context of the computing device; means for determining a user profile based on the context data, the user profile indicative of a typical behavior of a user of the computing device; means for determining a plurality of available platform capabilities of the computing device; means for determining a recommended platform capability of the plurality of available platform capabilities based on the user profile; and means for notifying the user of the recommended platform capability.

Example 37 includes the subject matter of Example 36, and wherein the means for determining the context data comprises means for retrieving context data indicative of a historical context of the computing device.

Example 38 includes the subject matter of any of Examples 36 and 37, and wherein the means for determining the context data comprises means for determining context data indicative of a current location of the computing device.

Example 39 includes the subject matter of any of Examples 36-38, and wherein the means for determining the context data comprises means for determining context data indicative of a currently available computing resource.

Example 40 includes the subject matter of any of Examples 36-39, and wherein the means for determining the available computing resource comprises means for identifying a wireless display, a network, or a proximate computing device.

Example 41 includes the subject matter of any of Examples 36-40, and wherein the means for determining the context data comprises means for determining context data indicative of application usage of the computing device.

Example 42 includes the subject matter of any of Examples 36-41, and wherein the means for determining the context data comprises means for determining context data indicative of content usage of the computing device.

Example 43 includes the subject matter of any of Examples 36-42, and wherein the means for determining the user profile comprises means for performing cluster analysis or frequency analysis to identify the typical behavior.

Example 44 includes the subject matter of any of Examples 36-43, and wherein the means for determining the plurality of available platform capabilities comprises means for determining at least one of a processor capability, a chipset capability, a hardware capability, or a software capability of the computing device.

Example 45 includes the subject matter of any of Examples 36-44, and wherein the means for determining the plurality of available platform capabilities comprises means for determining at least one of a wireless display capability, an anti-theft capability, a near-field communication capability, a collaborative networking capability, a standby network update capability, a remote wake capability, a hardware root of trust capability, or a content protection capability.

Example 46 includes the subject matter of any of Examples 36-45, and wherein the means for determining the recommended platform capability comprises means for selecting a recommendation template matching the user profile from a plurality of pre-defined recommendation templates, the recommendation template identifying the recommended platform capability.

Example 47 includes the subject matter of any of Examples 36-46, and further including means for receiving a recommendation template from a recommendation service.

Example 48 includes the subject matter of any of Examples 36-47, and further including means for transmitting the user profile to the recommendation service.

Example 49 includes the subject matter of any of Examples 36-48, and further including means for determining whether the recommended platform capability is relevant to the current context of the computing device; wherein the means for notifying the user of the recommended platform capability comprises means for notifying the user in response to determining that the recommended platform capability is relevant to the current context of the computing device.

Example 50 includes the subject matter of any of Examples 36-49, and wherein the means for notifying the user of the recommended platform capability comprises means for determining a notification rate of the computing device; means for determining whether the notification rate has a predefined relationship to a threshold notification rate; and means for notifying the user in response to determining the notification rate has the predefined relationship with the threshold notification rate.

Example 51 includes the subject matter of any of Examples 36-50, and further including means for installing a software component enabling the recommended platform capability.

1. A computing device for recommending platform features, the computing device comprising:
a context module to determine context data indicative of a context of the computing device;
a user profile module to determine a user profile based on the context data, the user profile indicative of a typical behavior of a user of the computing device;
a platform features module to determine a plurality of available platform capabilities of the computing device;
a recommendation module to determine a recommended platform capability of the plurality of available platform capabilities based on the user profile; and
an alert module to notify the user of the recommended platform capability.

2. The computing device of claim 1, wherein to determine the context data comprises to retrieve context data indicative of a historical context of the computing device.

3. The computing device of claim 1, wherein to determine the context data comprises to determine context data indicative of a current location of the computing device.

4. The computing device of claim 1, wherein to determine the context data comprises to determine context data indicative of a currently available computing resource.

5. The computing device of claim 4, wherein the available computing resource comprises a wireless display, a network, or a proximate computing device.

6. The computing device of claim 1, wherein to determine the context data comprises to determine context data indicative of application usage of the computing device or content usage of the computing device.

7. The computing device of claim 1, wherein the plurality of available platform capabilities comprises at least one of a wireless display capability, an anti-theft capability, a near-field communication capability, a collaborative networking capability, a standby network update capability, a remote wake capability, a hardware root of trust capability, or a content protection capability.

8. The computing device of claim 1, wherein:
to determine the recommended platform capability comprises to select a recommendation template to match the user profile from a plurality of pre-defined recommendation templates, the recommendation template to identify the recommended platform capability; and
the recommendation module is further to receive a recommendation template from a recommendation service.

9. The computing device of claim 8, wherein the user profile module is further to transmit the user profile to the recommendation service.

10. The computing device of claim 1, wherein:
the alert module is further to determine whether the recommended platform capability is relevant to the current context of the computing device; and
to notify the user of the recommended platform capability comprises to notify the user in response to a determination that the recommended platform capability is relevant to the current context of the computing device.

11. The computing device of claim 1, wherein to notify the user of the recommended platform capability comprises to:
determine a notification rate of the computing device;
determine whether the notification rate has a predefined relationship to a threshold notification rate; and
notify the user in response to a determination that the notification rate has the predefined relationship with the threshold notification rate.

12. The computing device of claim 1, further comprising an installation module to install a software component to enable the recommended platform capability.

13. A method for recommending platform features, the method comprising:
determining, by a computing device, context data indicative of a context of the computing device;
determining, by the computing device, a user profile based on the context data, the user profile indicative of a typical behavior of a user of the computing device;
determining, by the computing device, a plurality of available platform capabilities of the computing device;
determining, by the computing device, a recommended platform capability of the plurality of available platform capabilities based on the user profile; and
notifying, by the computing device, the user of the recommended platform capability.

14. The method of claim 13, wherein determining the context data comprises retrieving context data indicative of a historical context of the computing device.

15. The method of claim 13, wherein determining the plurality of available platform capabilities comprises determining at least one of a wireless display capability, an anti-theft capability, a near-field communication capability, a collaborative networking capability, a standby network update capability, a remote wake capability, a hardware root of trust capability, or a content protection capability.

16. The method of claim 13, further comprising determining, by the computing device, whether the recommended platform capability is relevant to the current context of the computing device;
wherein notifying the user of the recommended platform capability comprises notifying the user in response to determining that the recommended platform capability is relevant to the current context of the computing device.

17. The method of claim 13, further comprising installing, by the computing device, a software component enabling the recommended platform capability.

18. One or more computer-readable storage media comprising a plurality of instructions that in response to being executed cause a computing device to:
determine context data indicative of a context of the computing device;
determine a user profile based on the context data, the user profile indicative of a typical behavior of a user of the computing device;
determine a plurality of available platform capabilities of the computing device;
determine a recommended platform capability of the plurality of available platform capabilities based on the user profile; and
notify the user of the recommended platform capability.

19. The one or more computer-readable storage media of claim 18, wherein to determine the context data comprises to retrieve context data indicative of a historical context of the computing device.

20. The one or more computer-readable storage media of claim 18, wherein to determine the plurality of available platform capabilities comprises to determine at least one of a wireless display capability, an anti-theft capability, a near-field communication capability, a collaborative networking capability, a standby network update capability, a remote wake capability, a hardware root of trust capability, or a content protection capability.

21. The one or more computer-readable storage media of claim 18, further comprising a plurality of instructions that in response to being executed cause the computing device to determine whether the recommended platform capability is relevant to the current context of the computing device;
wherein to notify the user of the recommended platform capability comprises to notify the user in response to determining that the recommended platform capability is relevant to the current context of the computing device.

22. The one or more computer-readable storage media of claim 18, further comprising a plurality of instructions that in response to being executed cause the computing device to install a software component enabling the recommended platform capability.
